(19) United States
(12) Patent Application Publication
(10) Pub. No.: US 2008/0089237 A1
(43) Pub. Date: Apr. 17, 2008

(54) SYSTEM AND METHOD FOR DYNAMIC NETWORK TRAFFIC PRIORITIZATION

(75) Inventors: Brett Molen, Draper, UT (US); Richard L. Ehlers, Park City, UT (US); Adam Assay, Springville, UT (US); John Thomas Welch, Orem, UT (US); Wael R. Midani, West Valley, UT (US)

Correspondence Address: THORPE NORTH & WESTERN, LLP., P.O. Box 1219, SANDY, UT, 84091-1219, US

(73) Assignee: iBAHN CORPORATION, South Jordan, UT (US)

(21) Appl. No.: 11/548,609

(22) Filed: Oct. 11, 2006

(51) Int. Cl. H04J 1/16

(52) U.S. Cl. 370/252; 370/389; 370/401

(57) ABSTRACT

A system and method are provided for dynamic network traffic prioritization. The method can include the operation of offering a plurality of network traffic prioritization options to a user on a network. A user selected network traffic prioritization option can be communicated to a network configuration device through the network. Another operation is using the network configuration device to configure a plurality of networking devices dynamically. This can provide network prioritization through the network based on the user's selected network traffic prioritizations.

### FIELD OF THE INVENTION

The present invention relates generally to computer network communications.

### BACKGROUND

One of the benefits that network traffic prioritization brings is the ability to differentiate levels of network service based on the type of traffic being prioritized. Current network traffic prioritization is often specified through standards 802.11q, 802.1p, (Quality of Service—QoS) which is a layer 2 specification and through standard RFC-791 (Type of Service—ToS) which is a layer 3 specification.

With QoS/ToS controls in place, users may receive the desired level of service for a specific type of traffic and such controls can prevent hackers from abusing the system to get higher quality at no additional cost. QoS/ToS also regulates the use of all levels of service to ensure the network is utilized fairly between the different levels. This prevents subscribers from over using applications with high bandwidth requirements and adversely affecting the experience of other users utilizing network resources.

With QoS/ToS, the network is able to more effectively offer time sensitive and bandwidth intensive services such as Voice over IP (VoIP) and Video on Demand (VoD). Each of these technologies has different requirements to maintain acceptable quality. Enabling QoS/ToS helps to successfully offer and scale these services. Good quality VoIP is time sensitive and demands high priority over other traffic to minimize delay and maintain acceptable call quality. Video on the other hand is bandwidth intensive and needs to have the proper priority and allocated bandwidth to perform well. It is also helpful to have mechanisms to throttle back allocated bandwidth used by bandwidth intensive applications if they pass specific thresholds and begin to affect overall network performance and/or other high priority applications.

Current networks can provide QoS/ToS. However, this prioritization is provided by statically configuring networking devices for types of data and the various levels of QoS/ToS the network is enabled to provide. Current systems can authenticate a user and provide the user with the proper network access by validating the users preconfigured authorization data such as user ID or MAC address and assigning them the already defined QoS/ToS. In addition, the defined QoS/ToS may be set globally for all users equally based on an application or application type.

One problem with current prioritization and bandwidth shaping control systems is that the prioritization and bandwidth control are set by a technician. The gateways and other network devices that control network prioritization and bandwidth are accessed every few months or years by the technician and the specific constraints and parameters for prioritization and bandwidth shaping are statically set by the technician. These constraints and parameters will remain the same unless the skilled technician changes the settings. As result, the fixed configurations do not change in response to changing network conditions, increased application usage, or user needs.

### SUMMARY OF THE INVENTION

A system and method are provided for dynamic network traffic prioritization. The method can include the operation of offering a plurality of network traffic prioritization options to a user on a network. A user selected network traffic prioritization option can be communicated to a network configuration device through the network. Another operation is using the network configuration device to configure a plurality of networking devices dynamically. This can provide network prioritization through the network based on the user's selected network traffic prioritizations.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram illustrating a system for providing dynamic network traffic prioritization in accordance with an embodiment of the present invention;

FIG. 2 is flow chart illustrating a method for providing dynamic network traffic prioritization in an embodiment;

FIG. 3 is a block diagram illustrating a more detailed embodiment of providing dynamic network traffic prioritization; and

FIG. 4 is a block diagram illustrating an embodiment of providing dynamic network traffic prioritization using a service provider's network.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the inventions as illustrated herein, which would occur to one skilled in the relevant art and having possession of this disclosure, are to be considered within the scope of the invention.

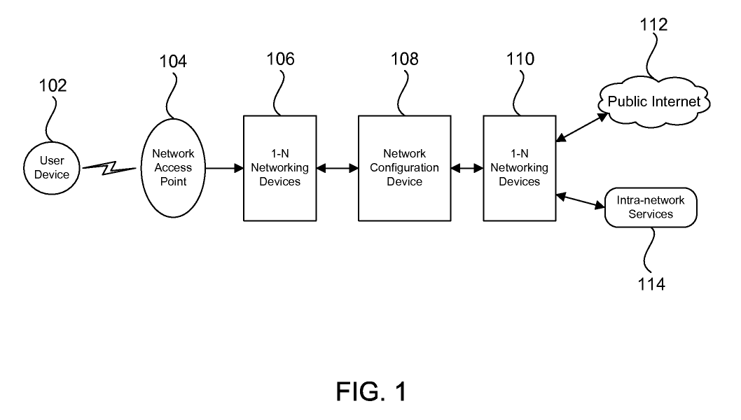

FIG. 1 illustrates a system of providing dynamic network traffic prioritization. The system can include a network access point 104 configured to enable a user device 102 to access a network. The network access point may be a wireless network access point or a physical Ethernet connection using a twisted pair or coaxial cable. The user device allows an end user to communicate with the network. The user device may be a desktop computer, laptop computer, a personal digital assistant (PDA), a cell phone, a thin computing device, or any other computing device than can connect to a network. The network may use protocols such as WiMAX or an Ethernet connection with the TCP/IP protocol, but other known networking protocols can be used.

One or more networking devices 106, 104, 110 can be provided to enable nodes in the network to provide dynamic priority network access for the user device 102. A network configuration device 108 can be in communication with the networking devices. The network configuration device is capable of enabling a user to choose network traffic prioritization options while using the network.

For example, the network configuration device may be a server or gateway which controls access to outside networks. When the end user desires to authenticate to the network, then the user may be presented with the option of increasing the priority of the user's network traffic in areas such as video streams, audio streams, or data. The priority options may present the simple option of purchasing a priority stream or leaving their stream as a non-priority stream. Alternatively, multiple levels of priority for each data stream type can be presented for purchase.

In addition, the network configuration device 108 can configure the accessible networking devices to provide network traffic prioritization at the user chosen network traffic prioritization. This means that the network configuration device can configure networking devices 106, 104, 110 from the user's network access point 104 to the exit point from an Internet service provider's network. This includes configuring networking devices on a LAN and a service provider's WAN. Examples of networking devices that may be configured for prioritization include: a network access point, a router, a switch, a bridge, a gateway, a proxy server, a firewall, general purpose servers, or other types of custom network controllers. These networking devices enable prioritized access to be provided to public networks such as the Internet 112. In addition, access can be provided to intra-network services 114 and internal nodes contained within the wide area network or other networks contained within the service provider's network.

The prioritization capabilities are also extendable to any peer network of the service provider, and/or LAN partners connected to any of the peers, and/or any partner application provider. If the appropriate security rights exist, then the selected prioritization may be passed on to a peer network and the user selected prioritization may continue through that network.

An embodiment of the invention includes a method that dynamically provides network prioritization to the network as selected or chosen by a user with respect to the data type used. For example, the user may have the authority to select or the ability to purchase different levels of priority for voice information, video information, data, or other types of network traffic streams.

The prioritization process can begin in response to the user's input when connecting to or logging into the network. In a publicly accessible network (e.g., a wireless network in a hotel, restaurant or fitness center) this input is combined with the authentication, authorization, and/or purchase credentials of the user to determine the proper level of service and access to the public network.

The user directed input may also originate through an application residing on the user's computer or mobile device which interacts with the network configuration device to request and be authenticated for the QoS/ToS service level. A desired level of service may be selected by the user through options provided in the application. Alternatively, the desired prioritization level may be set because a user has authorization to launch a specifically prioritized application. The application can interact with the gateway and obtain the network prioritization attributes. For example, users who are authorized or have purchased the right to launch a video application may also have prioritization dynamically set for them based on their selection of using the video application. This will work whether on a public or private network.

In another embodiment of the system and method, bandwidth shaping can be provided along with the prioritization of the network traffic for users. Bandwidth throttling or caps may be included for the prioritized network traffic in response to the user's selected network traffic prioritizations or bandwidth shaping can be applied by the network independently. The rate at which the traffic is being sent can also be limited. Bandwidth shaping levels may be purchased separately from the prioritizations via user selections or applied along with prioritization. An example of a cap may be a 256K cap for a single user's stream, a cap on a voice quality connection, or a cap that will allow High Definition television to be streamed through the user's connection.

A cap or other bandwidth shaping rule may be changed or throttled in response to the total number of prioritized and unprioritized users who are using the network at any given time. Another dynamic configuration scenario can be where prioritized traffic has less bandwidth restrictions than non-prioritized traffic as the network's load increases. In other words, the cap values on non-prioritized traffic may be reduced while the prioritized traffic caps remain the same because the overall network traffic is increasing.

Another dynamic bandwidth allocation situation is where the service provider's network can dynamically allocate network bandwidth available to prioritized traffic streams or to the entire network. The bandwidth allocation can be changed by notifying a service provider and/or the service provider's hardware devices to modify bandwidth allotted by the service provider's network (e.g., WAN) to a local network (e.g., LAN) based on prioritized traffic load.

For example, there are smart routing devices and switches which are used by many service providers. When these smart routing devices receive the appropriate authorized communications, the routing device can increase or decrease the total amount of bandwidth that is available to an individual stream or to a connected network. As users select or purchase prioritization and bandwidth shaping options, then the network configuration device or gateway can send a message to the service provider's networking devices to increase the overall bandwidth through specific routers and other networking equipment. When prioritized user's logoff the network, then a message can be sent by the network configuration device to the service provider's networking equipment or router to de-allocate or reduce the amount of available bandwidth.

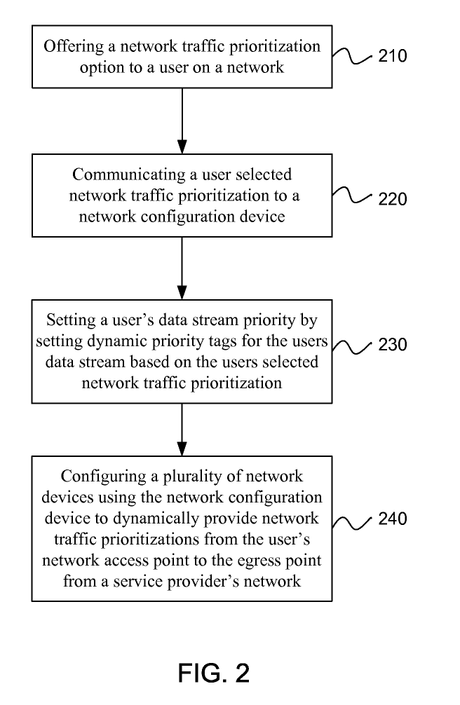

FIG. 2 illustrates an embodiment of a method to supply dynamic network traffic prioritization. The method includes the operation of offering a plurality of network traffic prioritization options to a user on a network, as in block 210. As discussed, this may include setting the priority to one of multiple possible priorities for specific data types. For example, 2 to 8 possible priority levels may be presented to the user for each data type (e.g. video, voice, and data). An increasing monetary charge may be associated with each increasing priority level. Alternatively, in the case of an internal corporate network where no charges may be applicable, a certain level of network rights may define the priority levels that a user can choose.

The user selected network traffic prioritization option can then be communicated to a network configuration device over the local area network, as in block 220. The selected option may be stored in a database associated with the network configuration device, along with the user ID. A user's data stream priority can be set by applying dynamic priority tags to the user's data stream based on the user's selected network traffic prioritization, as in block 230. The dynamic priority tags that are set for the data stream may be based upon the layer 2 or layer 3 networking specifications depending on the types of devices that are being configured for prioritization.

The network configuration device can dynamically configure a plurality of networking devices in order to provide network prioritization through the network based on the user's selected network traffic prioritizations, as in block 240. After authenticating and authorizing the user for a certain level of service, the system analyzes the user's data stream to find the dynamic prioritization tags representing the priority levels, which can be honored at all the preconfigured network devices that the data traverses through while on the network. This provides the data the appropriate network prioritization across the entire network.

In other words, the configuration may be applied to all the network devices on the network including the data's exit point which connects to other ISPs' networks or an Internet backbone. This configuration of networking devices may also be extended to peer WAN networks, partner LANs and partner application providers. When the corresponding incoming data stream arrives at the prioritized network(s), the system also prioritizes the data streams with the appropriate QoS/ToS tags as it is transmitted on to the user's device. This helps to provide prioritized network access in both traffic flow directions that matches the user's selected network traffic prioritization.

The configuration of the network devices may be limited to the network devices that are contained with a local area network (LAN) in one embodiment. This way if the owner of the network configuration device does not have access to control the priority for any other outside network, then prioritization can be set from the user's network access point to the exit point of the LAN.

In a similar manner, the configuration may take place for network devices on a local area network (LAN) and a service provider's wide area network (WAN) using the network configuration device. While it is valuable to configure as many network devices as possible to appropriately process dynamic prioritization tags, the configuration of network devices may be limited to selected network devices that are at key points for maintaining prioritization of the user's data streams as they are transmitted through the network.

Embodiments of the invention can also be provided where both end points of the data transmission will be located on the service provider's (ISP) network. In this case, the network configuration device can configure the networking devices between the endpoints to enforce the QoS/ToS service level guarantees end-to-end throughout the entire session. Most or all of the networking devices (to which a network configuration device has security access) can be configured to appropriately handle prioritization between a source communication point and destination communication point or vice-versa.

This end-to-end scenario means the network configuration device can dynamically configure the networking devices on a first local area network (LAN), on a service provider's wide area network (WAN), and on a second LAN that receives service from the service provider' network. The configuration can provide each of the networking devices with the rules or logic to correctly process the network traffic prioritizations from the user's network access point through the service provider's network and on through a second network access point on the second LAN. The second network access point may be a second user who is sending live video or audio to the first user. Alternatively, the second network access point may be a server that is sending prioritized data to the user.

In one embodiment, the configuration of multiple network devices may be applied from the user's network access point to the exit point from a service provider's network to provide the user's selected network traffic prioritization. It is also possible to configure other devices that are outside of the networking points described above, if the proper rights are granted by the respective service providers. In other words, any networking device on a LAN, WAN or the Internet may be configured to prioritize the network traffic as long as the owner of the networking device agrees to allow the configuration.

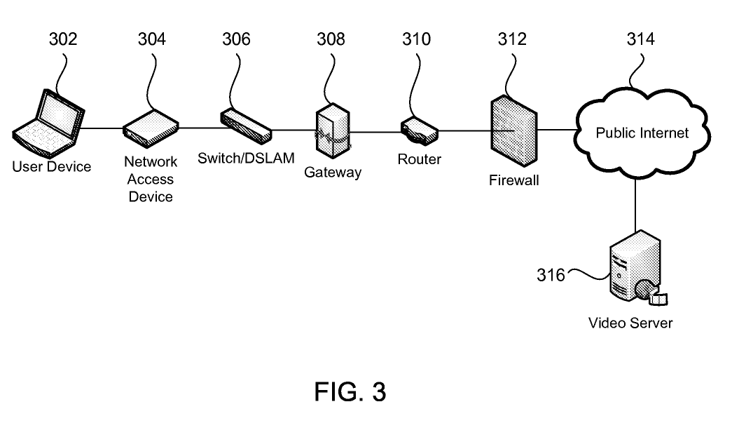

FIG. 3 illustrates an embodiment of a local network used together with an ISP network. The user can connect a user device 302 to the network access device 304. The network access device is connected through one or more switches 306 to a gateway 308.

In one embodiment, the gateway 308 performs the function of authentication and authorization. When the user is accessing a publicly accessible network where charges apply for usage or the acceptance of Terms of Use is required, the user typically goes through an open authentication sequence using a standard browser. Once the authentication and authorization for the user has taken place and the user has purchased or selected the priority level for a specific data stream type, then the gateway can define and apply the dynamic priority tags to data streams for the user, as the user accesses a public network.

The user may be presented with a web page or a graphical user interface window giving the user prioritization options. These options include the ability to select attributes or prioritization levels requesting that higher network prioritization be given to all the user's traffic or specific types of traffic for the user. QoS options may include prioritization for video, VoIP traffic, or higher priority for all traffic types from the user.

For example, a user may be asked to select the type of information stream the user wants to prioritize, and selections such as voice information, video information, data, HTTP, FTP, or other data types may be presented. Once the user picks the data type, then one or more priority levels can be presented. So, the user may be presented with any number of priority levels (e.g. 2-20 levels) and each level may include a higher price tag.

In the case where a user chooses a higher priority for their video traffic knowing they will view streaming videos, this dynamic prioritization tag or attribute selection can be handled by the gateway which dynamically configures the networking devices along the data path in the ISP network to provide network prioritization for the user's video traffic. The configuration may allow the user to experience uninterrupted video viewing on the designated device. The priority for the user's data stream is set based on a priority level chosen by a user for a data stream type selected, such as voice information, video information, and data.

Another way in which the priority level can be selected by a user is by having the network determine the user's network identification when the user enters their network identification or login. This allows the network configuration device to configure the networking devices in response to a user's network identification. The network identification of the user may belong to a loyalty or special benefits program. For example, the user may be a Gold Club member for a hotel, café, restaurant, airport Wi-Fi spot, airline or another organization. When the network identification is verified as being part of the loyalty club, then the user may be provided with network prioritization and bandwidth shaping that has been defined for the loyalty group in advance. An option to select and pay for additional prioritization and bandwidth over and above the loyalty settings may also be provided.

In some situations, the user's network identification may simply be a promotional code or special access code that is entered by the end user which provides a defined level of priority access for a determined period of time. In a similar method, the network prioritization can be provided in response to a software application that is started using the user's network identification or special access code.

The gateway 308 or network configuration device can configure any or all of the devices in the path such as the network access device, switch(s), router(s) and/or the firewall. Some switches 306, routers 310, and firewalls 312 may be configured because they are located within an Internet Service Provider's network to which the network configuration device has access rights.

The network configuration device or gateway may translate dynamic priority tags that are communicated between a local area network (LAN) and the service provider's wide area network (WAN). This is because a portion of the LAN may use different priority tags or tags in a different layer than the WAN. For example, a LAN using layer 2 priority tags can pass traffic to the WAN which is using layer 3 priority tags. Because the priority tag formats and values of the tags are significantly different between the layers, this conversion can be performed by the gateway. Another result of the conversion is that the user selected priority can be maintained and properly translated through the local and partner LANs, provider and peer WANs, as well as by partner application providers even though the prioritization schemes and the networking layers which transport the prioritization values or tags are different.

This translation also provides another valuable result in certain embodiments because the translation allows the gateway to set the priority for layer 2 packets received from the LAN and map the priority to the appropriate layer 3 priority as the packets are transformed into layer 3 packets on the WAN. At this point, the gateway can detect the type of stream that was prioritized for the user by checking the gateway's prioritization database. Then the gateway can set a user's network traffic prioritizations by setting dynamic priority tags for each of a user's prioritized data streams. Data streams that are not prioritized will remain at the lower priority.

While a layer 2 to layer 3 conversion process is described above, prioritization may be used at other layers, if desired. In addition, all the devices on the network may be layer 3 devices which would reduce or avoid the need for translation.

The gateway may not perform the networking device configuration itself, but some other active device or intelligent device in the network may perform the actual configuration. For example, a separate server or customized network configuration device within the WAN or LAN may perform the configuration. The type of device or core device functions are not as important as the fact that the device used is intelligent enough to perform the configuration of networking devices dynamically based on real-time input from the end user. For example, the network configuration device may be a gateway, router, intelligent switch, intelligent bridge, proxy server, a firewall, or a custom network controller.

Another embodiment of the invention enables a user during the user's session to dynamically change the priority tags for data streams. With this capability, the user in the video example may stop viewing videos and now need to switch to voice communication using a VoIP application. Using VoIP requires a different network prioritization than video, so the system allows the user to interact with web pages or through the application on the user's device to switch the prioritization over to voice network prioritization and optimize their network access for VoIP.

The following pseudocode shows a simplified implementation that applies to the situation where a user has selected certain priority criteria and is using a gateway that distinguishes priority for the following data types: Video, Voice and Data. This pseudo code in no way limits the scope of this invention to distinguishing only these three data types. In other words, any data stream that can have a defined Quality of Service or Type of Service applied to the stream may be prioritized by the user. The following logic could reside in any node in the network and be executed to set the priority for a type of data that has already been selected by the user.

```
For each packet from user device
{
    If (User selected priority option)
    {
        Switch( Data type)
        {
        Case Video:
            Set COS/TOS to Video priority level
            Break;
        Case Voice:
            Set COS/TOS to Voice Priority level
            Break;
        Case Data:
        Case default:
            Set COS/TOS to Data Priority level
            Break;
        }
    }
    Else
    {
        Set COS/TOS to default priority level
    }
}
```

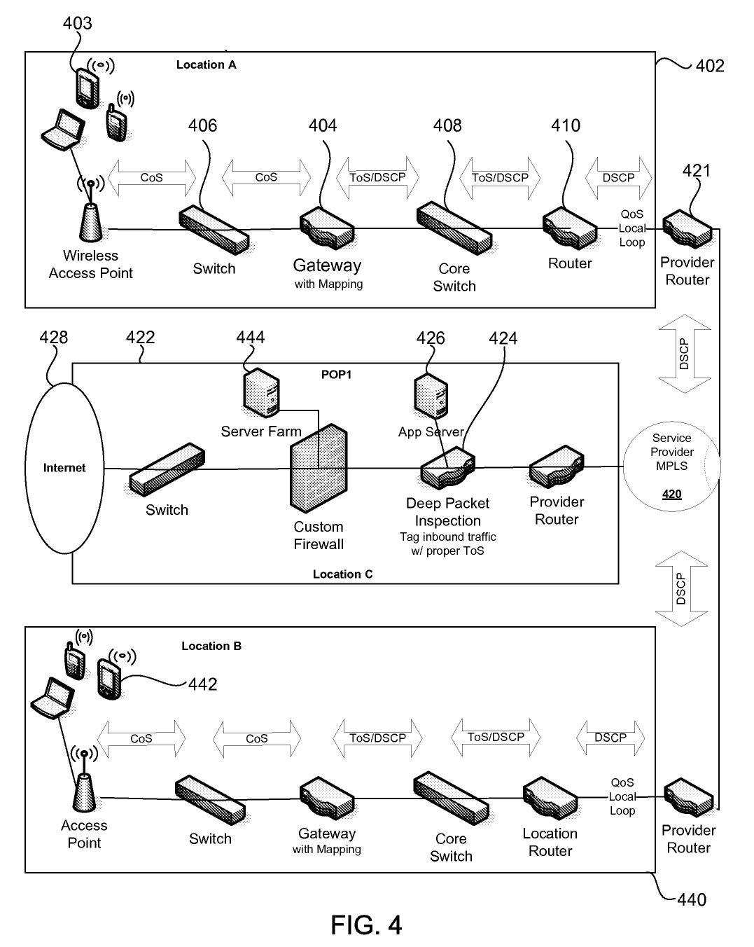

FIG. 4 illustrates an example of a local area network 402 with a gateway 404 that can configure other networking devices on the network. The configuration allows the networking devices to appropriately handle the dynamic priority tags that are set in a user's data stream by the gateway or another intelligent networking device.

The gateway can configure switches and routers 406-410 within a local area network (LAN). The gateway may also have access to an internet service provider's networking devices 420, 421 and networking devices in an accompanying point of presence (POP) 422. This allows the gateway to configure the networking devices on the service provider's network such as a provider's router and MPLS device (Multi-Protocol Label Switching). The networking devices in the POP can also be configured to handle the dynamic prioritization tags.

The outgoing user data can have a dynamic priority tag or priority level field added to the data packets when the packets are transmitted through the local network. This may occur using the gateway but the traffic may be prioritized by the user before it reaches the gateway. The configured network devices can recognize the dynamic priority tags at the desired networking layer and take the appropriate action. For example, the devices may be configured to: move the packets with the increased priority to a priority queue, change queue sizes or change the number of individuals that can participate in QoS (Quality of Service). In addition, the networking devices may use other quality of service methods or apply other known networking prioritization methods.

The gateway also makes prioritization in the present embodiment more hacking and spoof resistant. As an example, if a user does not purchase prioritization from the gateway but tries to spoof the priority of their packets, the gateway will detect a user who is not an authorized priority user and reduce the priority of the user's data streams. For example, some applications, such as video applications, may automatically request the highest priority for their data stream. However, the present system will demote such requests to a default priority or low priority if the user has not purchased a higher priority or if the user does not have the rights to select such priority. In a similar manner, the default priority for users and communication streams may be the lowest priority unless they have purchased or have the rights to have a higher priority applied by the gateway.

It is also desirable to be able add dynamic prioritization tags to the data coming back into the network from the outside public networks. This maintains the prioritization in both data flow directions. For example, a deep packet inspection device 424 can identify the data streams that are addressed for the prioritized user. Then the deep packet inspection device or the application server 426 can also determine the type of data stream that is returning through the network and apply the appropriate dynamic prioritization tag to the data stream and packets. Of course, if the stream is not a priority stream then the stream remains at a lower priority.

Another embodiment of the invention is where both end points of the data communication are contained on the ISP network and no traffic will go through the public internet 428. The embodiment of FIG. 4 illustrates a second location and local area network 440 that is attached to or contained within the service provider's network. In this embodiment, the gateway or network configuration device will configure many or even all of the networking devices between the first user 403 and the second data source (e.g., a user 442 or a server 444) to provide the requested network prioritization. If the communication is a peer-to-peer application with two users on the ISP's network, both users may have to select the network prioritization attribute to ensure end-to-end network prioritization of the data between the two users' devices. More generally speaking, where both a source and a destination of network traffic reside on a service provider's network, then the networking devices between the source and the destination can be configured for network prioritization from the source to the destination.

One result of the present invention is that the user is able to dynamically change a selected priority for their own network traffic without disconnecting and reconnecting to the network. The user may have been connected to the network for some time and then decide to prioritize a specific type of data stream. If the user wants to increase the priority of a second stream while reducing the priority of a first stream, this is also possible with the present system and method. In the past, this would not have been possible because the network priorities have been statically configured by network technicians.

In a similar manner, the present invention allows end users to separately set dynamic priority tags in a portion of a user's traffic for which prioritization has been purchased and leave priorities for a remainder of the user's traffic at a previous prioritization. This may improve the overall performance of the network because even prioritized users generally do not have every data stream prioritized but only the types that are important to the user during a given time frame. Thus, the network may provide better performance because lower overall volumes of network traffic will be prioritized.

Such prioritization systems and methods also allow users to purchase or pay for prioritization in time increments. If the user expects a video meeting to last one hour, then the user can purchase one hour of prioritization time. Frequent users of a prioritization service may purchase blocks of time.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A method of providing dynamic network traffic prioritization, comprising:
offering a plurality of network traffic prioritization options to a user on a network;
communicating a user selected network traffic prioritization option to a network configuration device; and
configuring a plurality of networking devices using the network configuration device in order to provide network prioritization through the network based on the user's selected network traffic prioritizations.

2. A method as in claim 1, further comprising the step of configuring the plurality of networking devices from the user's network access point to an exit point from a service provider's network to provide the user's selected network traffic prioritization.

3. A method as in claim 1, further comprising the step of configuring the plurality of networking devices to provide the user's selected network traffic prioritization from the user's network access point to a network selected from the group consisting of: a peer network, a partner LAN, and an application provider's network.

4. A method as in claim 1, further comprising the step of configuring the plurality of networking devices, to which a network configuration device has security access, between a source communication point and destination communication point.

5. A method as in claim 1, further comprising the step of setting a user's network traffic prioritizations by setting dynamic priority tags for a user's prioritized data stream using a gateway.

6. A method as in claim 5, further comprising the step of setting a user's data stream priority based on a priority chosen by the user for a data stream type selected from the group consisting of voice information, video information, and data.

7. The method as in claim 1, further comprising the step of using the network configuration device to translate dynamic priority tags that are communicated between a local area network (LAN) and the service provider's wide area network (WAN).

8. The method as in claim 1, further comprising the step of using the network configuration device to translate dynamic priority tags that are communicated between a local area network (LAN) and a network selected from the group consisting of: a peer network, a partner LAN, and an application provider's network.

9. The method of claim 1, further comprising the step of enabling the user to purchase higher network traffic prioritizations.

10. The method of claim 1, wherein the network configuration device is selected from the group consisting of a gateway, a router, a switch, a proxy server, a firewall, and a custom network controller.

11. The method of claim 1, further comprising the step of setting the dynamic priority tags as part of the authentication and authorization process for access to a public network.

12. The method of claim 1, further comprising the step of setting dynamic priority tags in a portion of a user's traffic for which prioritization has been purchased and leaving priorities for a remainder of the user's traffic at a previous prioritization.

13. The method of claim 1, further comprising the step of setting priority tags to a default prioritization in a user's traffic when an application has requested a higher prioritization which is not available to the user.

14. The method of claim 1, further comprising the step of communicating with the network configuration device using an application on a user device to select the dynamic prioritization levels and provide prioritized network access.

15. The method of claim 1, further comprising the step of enabling the user to change a selected priority for the user's network traffic without disconnecting from and reconnecting to the network.

16. The method as in claim 1, wherein the network priority option can provide a plurality of network priority levels to a user.

17. The method as in claim 1, further comprising the step of applying bandwidth shaping for the prioritized network traffic along with the user's selected network traffic prioritizations.

18. The method as in claim 1, further comprising the step of providing a dynamically prioritized bandwidth restriction, wherein non-prioritized traffic bandwidth restrictions increase compared to non-prioritized traffic as the network's load increases.

19. The method as in claim 1, further comprising the step of dynamically allocating network bandwidth available to prioritized network traffic by notifying a service provider to modify bandwidth allotted by a service provider's network to the network in response to prioritized traffic load.

20. A method of providing dynamic network traffic prioritization, comprising:
offering a network traffic prioritization option to a user on a network;
communicating a user selected network traffic prioritization to a network configuration device through the network;
setting a user's data stream priority by setting dynamic priority tags for the user's data stream based on the user's selected network traffic prioritization; and
configuring a plurality of network devices using the network configuration device to dynamically provide network traffic prioritizations from the user's network access point to the exit point from a service provider's network.

21. The method as in claim 20, further comprising the step of using the network configuration device to translate dynamic priority tags that are communicated between a local area network (LAN) and the service provider's wide area network (WAN).

22. A system of providing dynamic network traffic prioritization, comprising:
a network access point configured to enable a user device to access a network;
a plurality of networking devices configured to enable nodes in the network to communicate with the network access point;
a network configuration device configured to enable a user to choose network traffic prioritization options while using the network and to configure the plurality of accessible networking devices to provide network traffic prioritization at the user defined network traffic prioritization.

23. A system as in claim 22, wherein network configuration device can configure networking devices from the user's network access point to the exit point from a service provider's network.

24. A system as in claim 22, wherein both a source and a destination of network traffic resides on a service provider's network and all devices between the source and the destination are configured for network prioritization from the source to the destination.

25. A method of providing dynamic network traffic prioritization, comprising:
offering a network traffic prioritization option to a user on a network;
enabling the user to select a network traffic prioritization that is communicated to a network configuration device through the network; and
configuring a plurality of network devices on a local area network (LAN) using the network configuration device to dynamically provide the network traffic prioritizations from the user's network access point to the exit point from the LAN.

26. A method as in claim 25, further comprising the step of setting a priority for a user's data stream by setting dynamic priority tags for the user's data stream based on the user's selected network traffic prioritization.

27. A method of providing dynamic network traffic prioritization, comprising:
offering a network traffic prioritization option to a user on a network;
enabling the user to select a network traffic prioritization via communication with a network configuration device through the network; and
configuring a plurality of network devices on a local area network (LAN) and a service provider's wide area network (WAN) using the network configuration device to dynamically configure each of the plurality of network devices to correctly process the network traffic prioritizations from the user's network access point to the exit point from a service provider's network.

28. A method as in claim 27, further comprising the step of setting a priority for a user's data stream by setting dynamic priority tags for the user's data stream based on the user's selected network traffic prioritization.

29. A method as in claim 27, further comprising the step of locating the network configuration device on the service provider's network.

30. A method of providing dynamic network traffic prioritization, comprising:
offering a network traffic prioritization option to a user on a network;
enabling the user to select a network traffic prioritization via communication with a network configuration device through the network; and
configuring a plurality of networking devices on a first local area network (LAN), a service provider's wide area network (WAN), and a second LAN that receives service from the service provider' network, wherein the configuration is performed using the network configuration device to dynamically configure each of the plurality of networking devices to correctly process the network traffic prioritizations from the user's network access point through the service provider's network and to a second network access point on the second LAN.

31. A method as in claim 30, wherein the configuring step further comprises the step of configuring all the networking devices to provide the selected network traffic prioritization between the user's network access point and a second access point on the second LAN that are contained within the service provider's network.

32. A method as in claim 30, further comprising the step of setting a priority for a user's data stream by setting dynamic priority tags for the user's data stream based on the users selected network traffic prioritization.

33. A method of providing dynamic network traffic prioritization, comprising:
offering a plurality of network traffic prioritization options to a user on a network;
communicating a user selected network traffic prioritization option to a network configuration device; and
configuring a plurality of networking devices using the network configuration device in order to provide network prioritization through the network in response to a user's network identification.

34. A method as in claim 33, further comprising the step of providing network prioritization based on the user's network identification which is part of loyalty program group.

35. A method as in claim 33, further comprising the step of providing network prioritization based on the user's network identification as part of a promotional offer group.

36. A method as in claim 33, further comprising the step of providing network prioritization in response to an application that is started with the user's network identification.

37. A method of providing dynamic network traffic prioritization, comprising:
offering a plurality of network traffic prioritization options to a user on a network;
communicating a user selected network traffic prioritization option to a network configuration device; and
configuring a plurality of networking devices using the network configuration device in order to provide network prioritization and bandwidth shaping for traffic through the network based on the user's selected network traffic prioritizations.

38. The method as in claim 37, further comprising the step of providing dynamically prioritized bandwidth restriction shaping where non-prioritized traffic has greater bandwidth restrictions than prioritized traffic as the network's load increases.

39. The method as in claim 37, further comprising the step of dynamically allocating total network traffic available to prioritized network traffic by notifying a service provider to modify bandwidth allotted by a service provider for an attached network based on prioritized traffic load.
